(19) United States
(12) Patent Application Publication
(10) Pub. No.: US 2021/0284334 A1
(43) Pub. Date: Sep. 16, 2021

(54) Methods of Use of Flow Sensors on Aerial Vehicles and Devices Thereof

(71) Applicant: Triton Systems, Inc., Chelmsford, MA (US)

(72) Inventors: Evangelos LIVIERATOS, Medford, MA (US); John BLUM, Petersham, MA (US); Arthur GAVRIN, Manchester, NH (US)

(21) Appl. No.: 17/198,907

(22) Filed: Mar. 11, 2021

Related U.S. Application Data
(60) Provisional application No. 62/988,242, filed on Mar. 11, 2020.

(51) Int. Cl. B64C 31/024; B64C 39/02

(52) U.S. Cl. CPC B64C 31/024; B64C 39/024; B64C 2201/104; B64C 2201/021; B64C 2201/082

(57) ABSTRACT

Methods of use of flow sensors on aerial vehicles and devices thereof are disclosed. The methods include a method for flow correction for a flow induced lifting device, a method for a first flight vehicle to autonomously follow a second flight vehicle, a method for providing an informed launch for a flight vehicle, and a method for thermal soaring. Flight vehicles configured to perform the method are also disclosed.

### CROSS-REFERENCE TO RELATED APPLICATIONS

This application claims priority to and benefit of U.S. Provisional Application Ser. No. 62/988,242 filed Mar. 11, 2020, entitled “Methods of Use of Flow Sensors on Unmanned Aerial Vehicles and Devices Thereof” which is incorporated herein by reference in its entirety.

### BACKGROUND

The use of unmanned aerial vehicles (UAVs) is becoming more prominent in a variety of settings, including by way of example military applications. There is an incentive to make the vehicles smaller with lower manufacturing costs, while maintaining high functionality. However, increased functionality often requires more on-board energy and a higher computational burden. Accordingly, there is a need for methods of providing increased functionality and efficiency, while at the same time minimizing computational burden.

The ability to measure flow around the UAV, as well as around other types of aerial vehicles, can be utilized to provide a number of operational functions to improve both functionality and efficiency of the UAV. The use of pressure sensors is limited by the noise floor, precluding accurate measurement of smaller flow structures. Accordingly, there is a need for an improved UAV that incorporates flow sensors that can accurately measure flow while at the same time minimizing computational burden. There is also a need for operational use cases that can benefit from such technology.

The present application is directed to these and other deficiencies in the art.

### BRIEF DESCRIPTION OF THE DRAWINGS

The present disclosure is described with reference to the following figures, which are presented for the purpose of illustration only and are not intended to be limiting.

In the drawings:

FIG. 1 is an illustration on an exemplary unmanned aerial vehicle (UAV) in accordance with one embodiment of the present invention.

FIG. 2 is a block diagram of an exemplary computing device for use on the UAV shown in FIG. 1.

FIG. 3 is a flowchart of an exemplary method of flow correction to improve performance using the exemplary UAV shown in FIG. 1.

FIG. 4 is a flowchart of an exemplary method of performing follow the leader operations using the exemplary UAV shown in FIG. 1.

FIG. 5 is a flowchart of an exemplary method of performing informed launch operations using the exemplary UAV shown in FIG. 1.

FIG. 6 is a flowchart of an exemplary method of performing thermal soaring operations using the exemplary UAV shown in FIG. 1.

### SUMMARY

One aspect of the present technology provides a method for flow correction for a flow induced lifting device. The method includes receiving, by a computing device, flow data from one or more sensors positioned on a surface of the flow induced lifting device. A structure of flow proximate to the flow induced lifting device is determined, based on the received flow data from the one or more sensors. At least one location of non-optimal flow in the structure of flow proximate to the flow induced lifting device is determined. At least one instruction is provided to optimize the flow structure at the at least one location of non-optimal flow.

In some examples, the surface of the flow induced lifting device is on a low pressure side of the flow induced lifting device.

In some examples, the at least one location of non-optimal flow comprise a laminar separation bubble.

In some examples, the one or more sensors are arranged in a matrix.

In some examples, the at least one instruction to optimize the flow structure comprises an instruction to change an angle of attack of the flow induced lifting device based on the at least one location of non-optimal flow in the structure of flow.

In some examples, the least one instruction to optimize the flow structure comprises an instruction to alter at least one characteristic of the flow induced lifting device.

In some examples, altering the at least one characteristic comprises altering the shape of the flow induced lifting device.

In some examples, altering the shape of the flow induced lifting device comprises adjusting one or more of a leading or a trailing edge of the flow induced lifting device to provide a leak path.

In some examples, the at least one instruction to optimize the flow structure comprises an instruction to alter the flow structure by a local flow from one or more flow sources positioned on the flow induced lifting device.

In some examples, the local flow is directed to the at least one location of non-optimal flow.

In some examples, the at least one instruction to optimize the flow structure comprises an instruction to alter the flow structure by one or more turbulators positioned on the flow induced lifting device.

In some examples, the one or more sensors comprises hair cell sensors.

In some examples, the at least one instruction to optimize the flow structure comprises an instruction to alter one or more of the hair cell sensors to act as a turbulator.

In some examples, the flow induced lifting device comprises a low Reynold's number lift system.

In some examples, the flow induced lifting device is located on an aircraft or an unmanned aircraft.

Another aspect of the technology includes a flight vehicle comprising one or more sensors. The flight vehicle further includes at least one of configurable hardware logic configured to be capable of implementing and a processor coupled to a memory and configured to execute programmed instructions stored in the memory comprising receiving flow data from one or more sensors positioned on a surface of a flow induced lifting device or proximate to the flow induced lifting device of the flight vehicle. A structure of flow proximate to the flow induced lifting device is determined, based on the received flow data from the one or more sensors. At least one location of non-optimal flow in the structure of flow proximate to the flow induced lifting device is determined. At least one instruction is provided to optimize the flow structure at the at least one location of non-optimal flow.

In some examples, the surface of the flow induced lifting device is on a low pressure side of the flow induced lifting device.

In some examples, the at least one location of non-optimal flow comprise a laminar separation bubble.

In some examples, the one or more sensors are arranged in a matrix.

In some examples, the at least one instruction to optimize the flow structure comprises an instruction to change an angle of attack based on the at least one location of non-optimal flow in the structure of flow.

In some examples, the at least one instruction to optimize the flow structure comprises an instruction to alter at least one characteristic of the flow induced lifting device.

In some examples, the altering the at least one characteristic comprises altering a shape of the flow induced lifting device.

In some examples, the altering the shape of the flow induced lifting device comprises adjusting one or more of a leading or a trailing edge of the flow induced lifting device to provide a leak path.

In some examples, the at least one instruction to optimize the flow structure comprises an instruction to alter the flow structure by a local flow from one or more flow sources positioned on the flow induced lifting device.

In some examples, the local flow is directed to the at least one location of non-optimal flow.

In some examples, the at least one instruction to optimize the flow structure comprises an instruction to alter the flow structure by one or more turbulators positioned on the flow induced lifting device.

In some examples, the one or more sensors comprise hair cell sensors.

In some examples, the at least one instruction to optimize the flow structure comprises an instruction to alter one or more of the hair cell sensors to act as a turbulator.

In some examples, the flow induced lifting device comprises a low Reynold's number lift system.

In some examples, the flow induced lifting device is located on an aircraft or an unmanned aircraft.

Another aspect of the present technology relates to a method for a first flight vehicle to autonomously follow a second flight vehicle. The method includes receiving, by a configurable hardware logic stored on the first flight vehicle, flow data from one or more sensors positioned on the first flight vehicle, wherein the flow data is based on one of a flow induced thrust or flow induced lift generated by the second flight vehicle. A relative location of the first flight vehicle with respect to the flow induced thrust or flow induced lift generated by the second flight vehicle is determined based on the received flow data. At least one operational action to follow the second flight vehicle is identified based on the determined relative location of the first flight vehicle with respect to the flow induced thrust or flow induced lift generated by the second flight vehicle.

In some examples, the method further includes determining the relative location of the first flight vehicle with respect to the flow induced thrust or flow induced lift generated by the second flight vehicle based on the received flow data further includes determining a time and frequency for the flow induced thrust or flow induced lift generated by the second flight vehicle. The relative location of the first flight vehicle with respect to the flow induced thrust or flow induced lift generated by the second flight vehicle is determined based on the determined time and frequency.

In some examples, the method further includes receiving one or more items of information encoded in the flow data from the one or more sensors positioned on the first flight vehicle based on one of the flow induced thrust or the flow induced lift generated by the second flight vehicle. The second flight vehicle is identified based on the received one or more items of information.

In some examples, the one or more items of information are encoded in the flow data based on one or more actions of the second flight vehicle.

In some examples, the one or more actions comprise a propeller pulse, a rudder or elevator waggle, or a roll maneuver.

In some examples, the determining the relative location of the first flight vehicle with respect to the flow induced thrust or flow induced lift generated by the second flight vehicle based on the received flow data comprises determining one or more of swirl from thrust, downwash from lift, or clean air.

In some examples, the one or more sensors comprise hair cell sensors.

Another aspect of the present technology includes a flight vehicle comprising one or more sensors. The flight vehicle further comprises at least one of configurable hardware logic configured to be capable of implementing and a processor coupled to a memory and configured to execute programmed instructions stored in the memory comprising receiving flow data from the one or more sensors, wherein the flow data is based on one of a flow induced thrust or flow induced lift generated by a second flight vehicle. A relative location of the flight vehicle with respect to the flow induced thrust or flow induced lift generated by the second flight vehicle is determined based on the received flow data. At least one operational action to follow the second flight vehicle is identified based on the determined relative location of the flight vehicle with respect to the flow induced thrust or flow induced lift generated by the second flight vehicle.

In some examples, determining the relative location of the flight vehicle with respect to the flow induced thrust or flow induced lift generated by the second flight vehicle is determined based on the received flow data further comprises determining a time and frequency for the flow induced thrust or flow induced lift generated by the second flight vehicle. The relative location of the flight vehicle with respect to the flow induced thrust or flow induced lift generated by the second flight vehicle is determined based on the determined time and frequency.

In some examples, the flight vehicle further comprises one of additional configurable hardware logic configured to be capable of implementing and programmed instructions stored in the memory comprising receiving one or more items of information encoded in the flow data from the one or more sensors based on one of the flow induced thrust or the flow induced lift generated by the second flight vehicle. The second flight vehicle is identified based on the received one or more items of information.

In some examples, the one or more items of information are encoded in the flow data based on one or more actions of the second flight vehicle.

In some examples, the one or more actions comprise a propeller pulse, a rudder or elevator waggle, or a roll maneuver.

In some examples, the determining the relative location of the flight vehicle with respect to the flow induced thrust or flow induced lift generated by the second flight vehicle based on the received flow data comprises determining one or more of swirl from thrust, downwash from lift, or clean air.

In some examples, the one or more sensors comprise hair cell sensors.

Yet another aspect of the technology includes a method for providing an informed launch for a flight vehicle. The method includes receiving, by a computing device, wind data over a period of time from one or more sensors positioned on the flight vehicle when the flight vehicle is in a perched state. A direction and a speed is determined from the wind data over the period of time. An opportunistic launch time is identified based on the determined direction and the speed from the wind data.

In some examples, the method further includes providing, by the computing device, an instruction to the flight vehicle to perform a launch at the opportunistic launch time.

In some examples, identifying the opportunistic launch time further comprises determining, by the computing device, one or more microweather patterns based on the determined direction and speed from the wind data over the period of time. The opportunistic launch time is identified based on the determined one or more microweather patterns.

In some examples, the opportunistic launch time is based on a head wind and a threshold wind speed.

In some examples, the one or more sensors comprise hair cell sensors.

A further aspect of the technology includes a flight vehicle comprising one or more sensors. The flight vehicle further comprises at least one of configurable hardware logic configured to be capable of implementing and a processor coupled to a memory and configured to execute programmed instructions stored in the memory comprising receiving wind data over a period of time from the one or more sensors when the flight vehicle is in a perched state. A direction and a speed is determined from the wind data over the period of time. An opportunistic launch time is identified based on the determined direction and the speed from the wind data.

In some examples, the flight device further includes one of additional configurable hardware logic configured to be capable of implementing and programmed instructions stored in the memory comprising providing an instruction to the flight vehicle to perform a launch at the opportunistic launch time.

In some examples, identifying the opportunistic launch time further comprises determining one or more microweather patterns based on the determined direction and speed from the wind data over the period of time. The opportunistic launch time is identified based on the determined one or more microweather patterns.

In some examples, the opportunistic launch time is based on a head wind and a threshold wind speed.

In some examples, the one or more sensors comprise hair cell sensors.

In some examples, the one or more sensors are positioned on an extendable member of the flight vehicle.

In some examples, the extendable member is configured to be retracted prior to launch.

In some examples, the flight vehicle is a fixed wing flight vehicle.

Another aspect of the present technology relates to a method for providing for thermal soaring. The method includes receiving, by a computing device, flow data from one or more sensors positioned on a flight vehicle. A change in bias in the flow data is determined. A presence of an updraft is determined from a thermal based on the determined change in bias.

In some examples, identifying the presence of the updraft further comprises identifying, by the computing device, a direction of travel of the updraft and a rotation relative to the ground plane of the updraft.

Another aspect of the present technology relates to a flight vehicle including one or more sensors. The flight vehicle further includes at least one of configurable hardware logic configured to be capable of implementing and a processor coupled to a memory and configured to execute programmed instructions stored in the memory comprising receiving flow data from the one or more sensors. A change in bias in the flow data is determined. A presence of an updraft from a thermal is determined based on the determined change in bias.

In some examples, identifying the presence of the updraft further comprises identifying a direction of travel of the updraft and a rotation relative to the ground plane of the updraft.

In some examples, the one or more sensors comprise hair cell sensors.

The present technology advantageously provides for the use of flow sensors on aerial vehicles that may be employed of operations such as a method for flow correction for a flow induced lifting device, a method for a first flight vehicle to autonomously follow a second flight vehicle, a method for providing an informed launch for a flight vehicle, and a method for thermal soaring. The use of flow sensors advantageously allows for determining flow for various operations while maintaining a low computational burden.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person in the art will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

Various terms are used herein consistent with their common meanings in the art. The following terms are defined below for clarity.

It must also be noted that as used herein and in the appended claims, the singular forms “a”, “an”, and “the” include plural reference unless the context clearly dictates otherwise. Thus, for example, reference to “an earplug” is a reference to “one or more earplug” and equivalents thereof known to those skilled in the art, and so forth.

As used herein, the term “about” means plus or minus 10% of the numerical value of the number with which it is being used. Therefore, about 50% means in the range of 45%-55%.

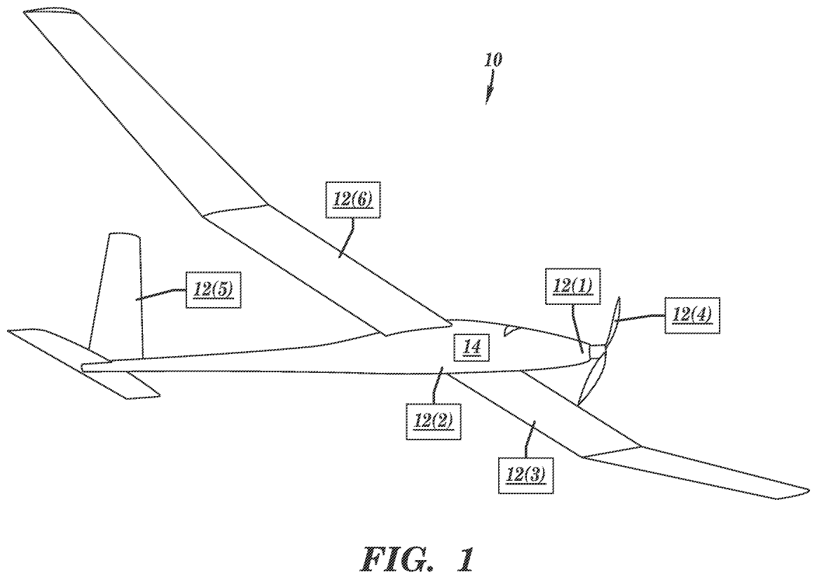

An example of an unmanned aerial vehicle (UAV) 10 is illustrated in FIG. 1.

Although an exemplary UAV is illustrated and described, it is to be understood that the methods described herein can be employed using other types of UAVs, or other vehicles configured to measure flow in the surrounding environment, having other configurations. Further, the methods described herein can also be utilized with other types of flight vehicles, such as manned aircraft vehicles by way of example. In this particular example, the UAV 10 includes a plurality of flow sensors 12(1)-12(n) located thereon and a computing device 14, although the UAV 10 may include other types and/or number of other systems, devices, components, and or other elements in other combinations. The plurality of flow sensors 12(1)-12(n) advantageously can be utilized in a number of operations of the UAV as described in the examples set forth herein, using the on-board computing device 14.

The plurality of flow sensors 12(1)-12(n) can be located at various locations on the UAV 10 on any of the components thereof. It is to be understood that the locations of the plurality of flow sensors 12(1)-12(n) may be varied based on the use case. In one example, one of more of the plurality of flow sensors 12(1)-12(n) are located on or adjacent to a flow induced lifting device of the UAV 10, such as the wings or propellers of the UAV 10. In one example, the flow induced lifting device may be an area on the outer mold line (OML) of the UAV 10, which would include the nose, empennage, and landing gear (for a fixed landing gear UAV).

In one example, the plurality of flow sensors 12(1)-12(n) may be positioned in a matrix. In one example, the plurality of flow sensors 12(1)-12(n) are hair flow sensors, such as described in U.S. Pat. No. 9,658,087, the disclosure of which is incorporated herein by reference in its entirety, although other types of flow sensors may be utilized. The use of hair flow sensors allows for determination of the flow based on time and frequency, which presents a low computational burden. The low computational burden allows for lower cost and more efficient UAVs, while obtaining the benefit of measuring the flow around the vehicle for the methods of use as described below. Further, the hair sensors provide the necessary level of sensitivity as opposed to pressure sensors, for which the noise floor would preclude the necessary accuracy of flow measurements.

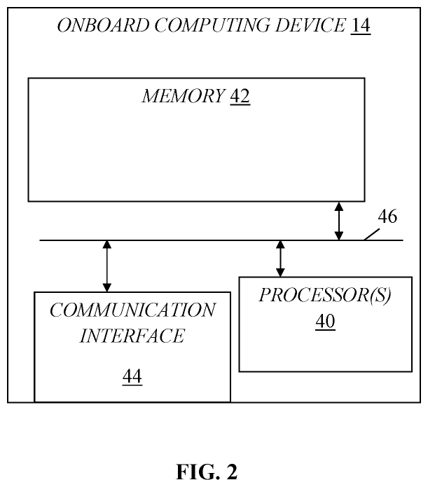

The plurality of flow sensors 12(1)-12(n) are coupled to the onboard computing device 14. Referring now more specifically to FIG. 2, the onboard computing device 14 in this example includes one or more processor(s) 40, a memory 42, and/or a communication interface 44, which are coupled together by a bus 46 or other communication link, although the onboard computing device 14 can include other types and/or numbers of elements in other configurations. In one example, the onboard computing device 14 is a microcontroller. In yet another example, the onboard computing device 14 comprises configurable hardware logic that allows the onboard computing device 14 to function as an analog device. In one example, the onboard computing device 14 may be comprised of several analog devices associated with each of the plurality of flow sensors 12(1)-12(n).

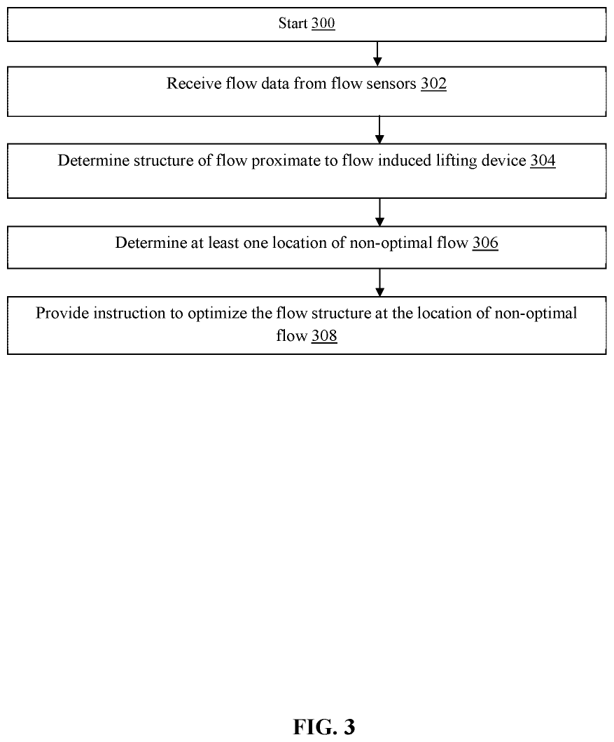

Referring again to FIG. 3, the processor(s) 40 of the onboard computing device 14 may execute programmed instructions stored in the memory 42 for the any number of the functions described and illustrated herein. In one example, the processor(s) 40 provides instructions to the UAV 10 for operation. In another example, the processor(s) 40 receive flow data from the plurality of flow sensors 12(1)-12(n) and processes flow data in the different modes described below. The processor(s) may 40 include one or more CPUs, GPUs, or general purpose processors with one or more processing cores, for example, although other types of processor(s) can also be used such as FPGA devices.

The memory 42 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory.

Accordingly, the memory 42 of the onboard computing device 14 can store one or more applications or programs that can include computer executable instructions that, when executed by the processor(s) 40 of the onboard computing device 14, cause the onboard computing device 14 to perform actions described below. The application(s) can be implemented as modules, threads, pipes, streams, or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s) may be running in one or more virtual machines (VMs) executing on the image acquisition computing device. The communication interface 44 operatively couples and communicates between the onboard computing device 14 and other computing devices that may be utilized to control one or more operations of the UAV 10.

In another example, the onboard computing device 14 is a highly integrated microcontroller device with a variety of on-board hardware functions, such as analog to digital converters, digital to analog converters, serial buses, general purpose I/O pins, RAM, and ROM.

Although the exemplary onboard computing device 14 is described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for the onboard computing device 14. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

Exemplary use cases of the UAV 10 of the present technology will now be described.

Laminar Bubble Mitigation

Low Reynolds number lift systems suffer the consequences of laminar separation bubbles. This is especially true for gliding systems, i.e., systems that travel without propulsion for at least part of their operations. UAVs, or sea gliders in another example, may be utilized in an autonomous soaring application that will result in laminar separation bubble issues. Laminar separation bubbles can form around a UAV, which severely increases drag and reduced performance of the UAV. The laminar separation bubbles also reduce lift and change the pitching moment of a lift system. The detection and mitigation of laminar separation bubbles can serve to increase the efficiency and overall operational performance of the UAV. An exemplary operation of the UAV 10 of the present technology to provide laminar bubble mitigation will now be described with reference to FIGS. 1-3. The exemplary operation starts in step 300.

In step 302, the onboard computing device 14 receives flow data from one or more of the plurality of flow sensors 12(1)-12(n). In this example, the plurality of flow sensors 12(1)-12(n) are positioned on a surface of a flow induced lifting device or proximate to the flow induced lifting device of the flight vehicle. In one example, the surface of the flow induced lifting device is on a low pressure side of the flow induced lifting device, although the plurality of flow sensors 12(1)-12(n) may be located on other surfaces of the UAV 10 in other locations. For example, a matrix of the plurality of flow sensors 12(1)-12(n) may be located on a wing of the UAV 10, although the plurality of flow sensors 12(1)-12(n) can be positioned in other locations.

In step 304, the onboard computing device 14 determines a structure of flow proximate to the flow induced lifting device, based on the received flow data from the plurality of flow sensors 12(1)-12(n). The structure of flow is determined based on the time and frequency values measured by the plurality of flow sensors 12(1)-12(n).

In step 306, the onboard computing device 14 determines at least one location of non-optimal flow in the structure of flow proximate to the flow induced lifting device based on flow sensor data from one of the plurality of flow sensors 12(1)-12(n) that is located proximate to the non-optimal flow. For example, the non-optimal flow may be a laminar bubble separation, although other non-optimal flows may be determined. The non-optimal flow may be determined based on a reversion or stagnation of the flow sensed by one or more of the plurality of flow sensors 12(1)-12(n).

Next, in step 308, the onboard computing device 14 provides at least one instruction to optimize the flow structure at the at least one location of non-optimal flow. The instruction allows the UAV 10 to take a corrective action to mitigate the non-optimal flow, such as a laminar separation bubble. In one example, the onboard computing device 14 provides an instruction for the UAV 10 to change the angle of attack, such as a reduction in the angle of attack, based on the at least one location of non-optimal flow in the structure of flow. In another example, the onboard computing device 14 provides an instruction to alter a characteristic of the flow induced lifting device. For example, the shape of the flow induced lifting device may be altered by mechanically adjusting a leading or trailing edge of part of the UAV 10, such as the wing or propeller, in order to optimize the flow structure, although other elements on the UAV 10 may be mechanically altered to optimize the flow structure. In other examples, a leak path may be formed away from the leading edge at the location of the laminar separation bubble on the surface of the flow induced lifting device. For example, a wing on the UAV 10 may open a leak path from high to low pressure to mitigate the laminar bubble. In another example, a local flow may be directed from a synthetic jet source to the location near the surface of the flow induced lifting device where the laminar bubble is located may be altered to optimize the flow structure. In a further example, the onboard computing device 14 can provide an instruction to introduce a turbulator at the location of the unwanted flow to interrupt formation of the laminar bubble. In another example, when the plurality of flow sensors 12(1)-12(n) are hair cell sensors, the onboard computing device 14 may provide an instruction for one or more of the plurality of flow sensors 12(1)-12(n) to act as a turbulator in order to optimize the flow structure. Air around the plurality of flow sensors 12(1)-12(n) may be moved by applying electricity to the hair cells themselves.

Follow the Leader

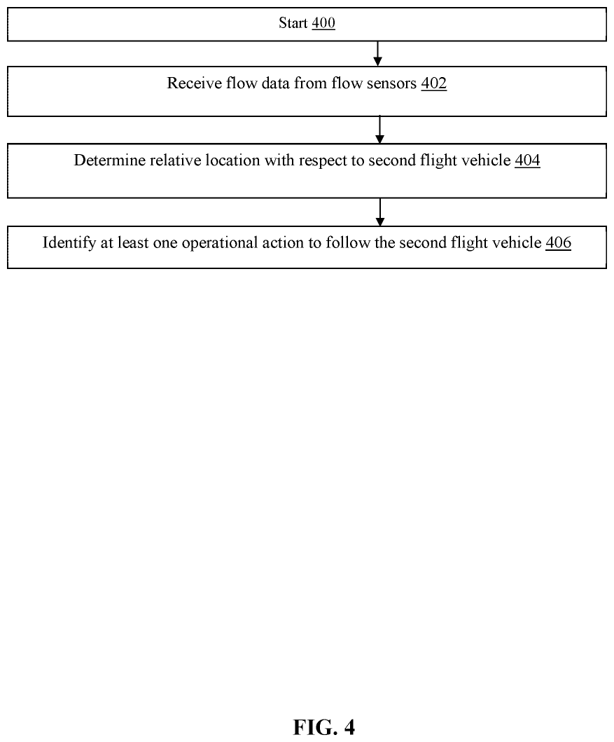

Follow the leader operations are performed to provide for swarming of UAVs, although follow the leader operations may be performed using other types of vehicles. In another example, follow the leader operations may be performed during subsea operations. Swarming operations allow for a large number of UAVs, or other vehicles, to act as a single unit. Detecting the presence among the swarm requires some real-time computational burden. Using the methods of the present technology, follow the leader operations may be performed using flow sensors to allow the UAVs to maintain their position in the swarm without the need for high computational burden, which allows for the UAVs to be smaller and lower cost. An exemplary operation of the UAV 10 of the present technology for performing follow the leader operations will now be described with reference to FIGS. 1, 2, and 4. This method may be advantageously utilized to allow the UAV 10 to autonomously follow a second flight vehicle. The exemplary operation starts in step 400.

In step 402, the onboard computing device 14 receives flow data from the plurality of flow sensors 12(1)-12(n). In this example, the flow data is based on a one of a flow induced thrust or flow induced lift generated by a second flight vehicle. In this example, the plurality of flow sensors 12(1)-12(n) may be located on a front portion of the UAV 10 to be able to detect flow from a second flight vehicle in a lead position with respect to the UAV 10. The plurality of flow sensors 12(1)-12(n) may also be located on a rear portion of the UAV 10 to detect flow for a second flight vehicle in a trail position with respect to the UAV 10.

In step 404, the onboard computing device 14 determines a relative location of the UAV 10 with respect to the flow induced thrust or flow induced lift generated by the second flight vehicle based on the received flow data. In one example, the onboard computing device 14 determines time and frequency values for the flow induced thrust or flow induced lift generated by the second flight vehicle and received by the plurality of flow sensors 12(1)-12(n). The relative location of the UAV 10 with respect to the flow induced thrust or flow induced lift generated by the second flight vehicle is then determined based on the determined time and frequency values. In one example, the plurality of flow sensors 12(1)-12(n) are trained using a neural network to identify the relative position. In another example, the plurality of flow sensors 12(1)-12(n) can identify whether they are positioned in a swirl, or not in a swirl, from a propeller of the second flight vehicle. The onboard computing device 14 may determine the relative position based on swirl from thrust, downwash from lift, or clean air, by way of example only. These methods can be utilized for UAVs with either a tractor configuration (propeller in the front) or a pusher configuration (propeller in the back).

In step 406, the onboard computing device 14 identifies at least one operational action to follow the second flight vehicle based on the determined relative location of the unmanned vehicle with respect to the flow induced thrust or flow induced lift generated by the second flight vehicle. The onboard computing device 14 therefore provides for the control strategy of the UAV 10 to maintain position in the swarm. In one example, the exemplary method is used in refueling operations.

The exemplary methods for follow the leader may also allow for the leader to identify itself to a UAV in a trail position. For example, the leader could identify itself by altering a flow pattern generated. The leader flight vehicle could perform an operational maneuver known in the art to generate a varied flow pattern such as a propeller pulse, a rudder or elevator waggle, or a roll maneuver. In this example, when UAV 10 is in a follow position, the plurality of flow sensors 12(1)-12(n) sense the change in flow pattern and the onboard computing device 14 recognizes the leader. This technique could also be used to encode information transferred form the leader to the UAV 10. In this example, the onboard computing device 14 receives items of information encoded in the flow data from the plurality of flow sensors 12(1)-12(n). The items of information are encoded using the flow induced thrust or the flow induced lift generated by the second flight vehicle, or the leader. Any items of information may be encoded using known encoding techniques. The onboard computing device 14 can then identify the second flight vehicle (leader) based on the received items of information.

Informed Launch

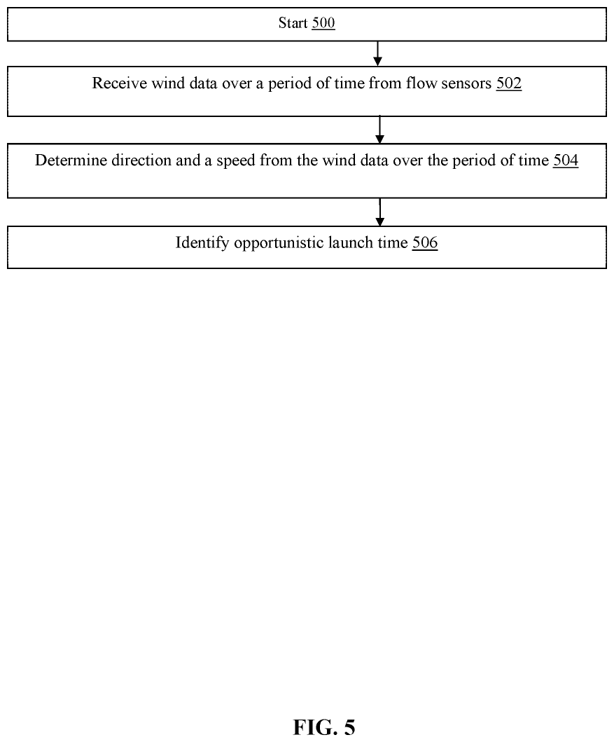

UAVs have an endurance limit, i.e., the amount of time they can spend in the air is limited. However, endurance is critical to operations such as intelligence, surveillance, and reconnaissance (ISR) missions performed by UAVs. Fixed wing UAVs have greater endurance than similarly sized rotary wing UAVs. However, ISR missions may involve opportunistic perching to increase the endurance limit, which necessarily requires taking off again. This presents a problem for fixed wing UAVs as they need to re-quire air to take off again form a perched position. Air speed and direction relative to a perched aircraft changes often in a typical environment. Measuring the air speed and direction and determining an advantageous launch time can be utilized to improve overall performance and endurance of the UAV. An exemplary operation of the UAV 10 of the present technology for performing an informed launch will now be described with reference to FIGS. 1, 2, and 5. This method may be advantageously utilized to allow the UAV 10 launch at an optimal time to conserve onboard resources. The exemplary operation starts in step 500.

In step 502, the onboard computing device 14 receives wind data over a period of time from the plurality of flow sensors 12(1)-12(n) positioned on the UAV 10 while the UAV 10 is in a perched state. For example, the UAV 10 may be perched on top of a building to obtain a view of a region of interest.

In step 504, the onboard computing device 14 determines a direction and a speed from the wind data over the period of time. The plurality of flow sensors 12(1)-12(n) may be located about the UAV 10 to be able to measure changes in the wind direction. In one example, the UAV 10 may have one or more extendable members from the body thereof that may be extended only in the perched state. The plurality of flow sensors 12(1)-12(n) can be located on the extendable members to provide better positions for sensing local wind patterns. The extendable members may then be retracted prior to launch.

In step 506, the onboard computing device 14 identifies an opportunistic launch time for the UAV 10 based on the determined direction and the speed from the wind data. The onboard computing device 506 may determine the opportunistic launch where the wind speed meets a threshold in a desirable direction, i.e., a head wind at a threshold speed. Alternatively, the launch may occur when the wind speed falls with a set of wind parameters. In one example, the UAV 10 may be perched on the edge of a building and may launch during a determined updraft. In another example, a second flight vehicle that is a rotary wing aircraft may be used to generate a ring vortex near the UAV 10 to provide a lifting flow. The onboard computing device 14 senses the uplifting flow based on data from the plurality of flow sensors 12(1)-12(n) to provide an opportunistic launch.

Thermal Soaring

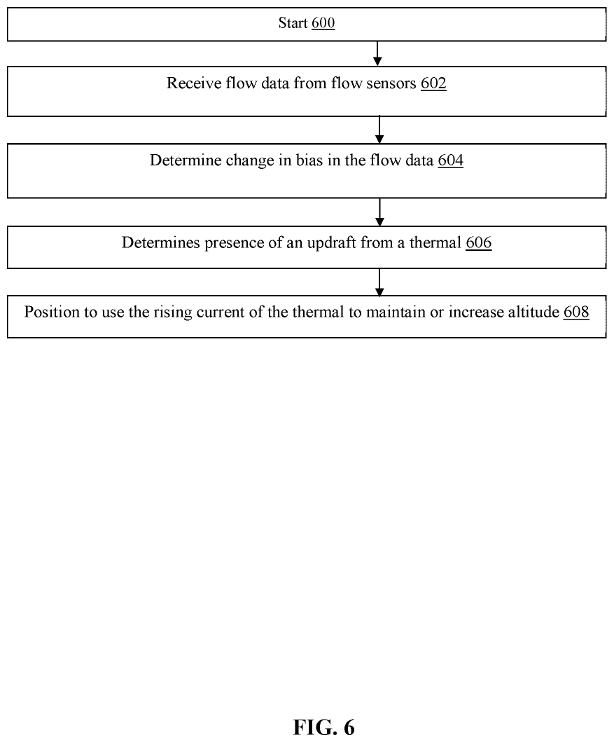

In autonomous soaring applications, UAVs can utilize updrafts from thermals to maintain or gain altitude. A fixed wing UAV can utilize thermals to extend flight indefinitely. However, thermals may be difficult to locate and identify. The ability to sense such updrafts would improve performance An exemplary operation of the UAV 10 of the present technology for performing thermal soaring will now be described with reference to FIGS. 1, 2, and 6. The exemplary operation starts in step 600.

In step 602, the onboard computing device 14 receives flow data from the plurality of flow sensors 12(1)-12(n) positioned on the UAV 10. The plurality of flow sensors 12(1)-12(n) may be positioned in a matrix on the underside of the UAV 10 in order to sense the flow from thermals.

In step 604, the onboard computing device 14 determines a change in bias in the flow data. The change in bias is measured over time.

In step 606, the onboard computing device 14 determines the presence of an updraft from a thermal based on the determined change in bias. The onboard computing device 14 can also determine the direction of travel of the thermal, and the rotation relative to the ground plane. In step 608, the UAV 10 can then utilize the information to position itself to use the rising current of the thermal to maintain or increase altitude.

The above exemplary use cases advantageously allow for improved performance and efficiency of UAVs using flow sensors. Further, the use of the flow sensors provides for a low additional computational burden for the UAV. Although described with respect to UAVs, it is to be understood that the exemplary operations could be performed using other vehicles, including other aerial vehicles, that are configured to measure flow.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed:

1. A method for flow correction for a flow induced lifting device, the method comprising:
receiving, by a computing device, flow data from one or more sensors positioned on a surface of the flow induced lifting device;
determining, by the computing device, a structure of flow proximate to the flow induced lifting device, based on the received flow data from the one or more sensors;
determining, by the computing device, at least one location of non-optimal flow in the structure of flow proximate to the flow induced lifting device; and
providing, by the computing device, at least one instruction to optimize the flow structure at the at least one location of non-optimal flow.

2. The method of claim 1, wherein the surface of the flow induced lifting device is on a low pressure side of the flow induced lifting device.

3. The method of claim 1, wherein the at least one location of non-optimal flow comprise a laminar separation bubble.

4. The method of claim 1, wherein the one or more sensors are arranged in a matrix.

5. The method of claim 1, wherein the at least one instruction to optimize the flow structure comprises an instruction to change an angle of attack of the flow induced lifting device based on the at least one location of non-optimal flow in the structure of flow.

6. The method of claim 1, wherein the at least one instruction to optimize the flow structure comprises an instruction to alter at least one characteristic of the flow induced lifting device.

7. The method of claim 6, wherein altering the at least one characteristic comprises altering the shape of the flow induced lifting device.

8. The method of claim 7, wherein altering the shape of the flow induced lifting device comprises adjusting one or more of a leading or a trailing edge of the flow induced lifting device to provide a leak path.

9. The method of claim 6, wherein the at least one instruction to optimize the flow structure comprises an instruction to alter the flow structure by a local flow from one or more flow sources positioned on the flow induced lifting device.

10. The method of claim 9, wherein the local flow is directed to the at least one location of non-optimal flow.

11. The method of claim 6, wherein the at least one instruction to optimize the flow structure comprises an instruction to alter the flow structure by one or more turbulators positioned on the flow induced lifting device.

12. The method of claim 6, wherein the one or more sensors comprises hair cell sensors.

13. The method of claim 12, wherein the at least one instruction to optimize the flow structure comprises an instruction to alter one or more of the hair cell sensors to act as a turbulator.

14. The method of claim 1, wherein the flow induced lifting device comprises a low Reynold's number lift system.

15. The method of claim 1, wherein the flow induced lifting device is located on an aircraft or an unmanned aircraft.

16. A flight vehicle comprising:
one or more sensors;
at least one of configurable hardware logic configured to be capable of implementing and a processor coupled to a memory and configured to execute programmed instructions stored in the memory comprising:
receiving flow data from one or more sensors positioned on a surface of a flow induced lifting device or proximate to the flow induced lifting device of the flight vehicle;
determining a structure of flow proximate to the flow induced lifting device, based on the received flow data from the one or more sensors;
determining at least one location of non-optimal flow in the structure of flow proximate to the flow induced lifting device; and
providing at least one instruction to optimize the flow structure at the at least one location of non-optimal flow.

17. The flight vehicle of claim 16, wherein the surface of the flow induced lifting device is on a low pressure side of the flow induced lifting device.

18. The flight vehicle of claim 16, wherein at least one location of non-optimal flow comprise a laminar separation bubble.

19. The flight vehicle of claim 16, wherein the one or more sensors are arranged in a matrix.

20. The flight vehicle of claim 16, wherein the at least one instruction to optimize the flow structure comprises an instruction to change an angle of attack based on the at least one location of non-optimal flow in the structure of flow.

21. The flight vehicle of claim 16, wherein the at least one instruction to optimize the flow structure comprises an instruction to alter at least one characteristic of the flow induced lifting device.

22. The flight vehicle of claim 21, wherein the altering the at least one characteristic comprises altering a shape of the flow induced lifting device.

23. The flight vehicle of claim 22, wherein altering the shape of the flow induced lifting device comprises adjusting one or more of a leading or a trailing edge of the flow induced lifting device to provide a leak path.

24. The flight vehicle of claim 21, wherein the at least one instruction to optimize the flow structure comprises an instruction to alter the flow structure by a local flow from one or more flow sources positioned on the flow induced lifting device.

25. The flight vehicle of claim 24, wherein the local flow is directed to the at least one location of non-optimal flow.

26. The flight vehicle of claim 21, wherein the at least one instruction to optimize the flow structure comprises an instruction to alter the flow structure by one or more turbulators positioned on the flow induced lifting device.

27. The flight vehicle of claim 21, wherein the one or more sensors comprises hair cell sensors.

28. The flight vehicle of claim 27, wherein the at least one instruction to optimize the flow structure comprises an instruction to alter one or more of the hair cell sensors to act as a turbulator.

29. The flight vehicle of claim 16, wherein the flow induced lifting device comprises a low Reynold's number lift system.

30. The flight vehicle of claim 16, wherein the flow induced lifting device is located on an aircraft or an unmanned aircraft.

31. A method for a first flight vehicle to autonomously follow a second flight vehicle, the method comprising:
receiving, by a configurable hardware logic stored on the first flight vehicle, flow data from one or more sensors positioned on the first flight vehicle, wherein the flow data is based on one of a flow induced thrust or flow induced lift generated by the second flight vehicle;
determining, by the configurable hardware logic stored on the first flight vehicle, a relative location of the first flight vehicle with respect to the flow induced thrust or flow induced lift generated by the second flight vehicle based on the received flow data; and
identifying, by the configurable hardware logic stored on the first flight vehicle, at least one operational action to follow the second flight vehicle based on the determined relative location of the first flight vehicle with respect to the flow induced thrust or flow induced lift generated by the second flight vehicle.

32. The method of claim 31, wherein determining the relative location of the first flight vehicle with respect to the flow induced thrust or flow induced lift generated by the second flight vehicle based on the received flow data further comprises:
determining, by the configurable hardware logic stored on the first flight vehicle, a time and frequency for the flow induced thrust or flow induced lift generated by the second flight vehicle; and
determining, by the configurable hardware logic stored on the first flight vehicle, the relative location of the first flight vehicle with respect to the flow induced thrust or flow induced lift generated by the second flight vehicle based on the determined time and frequency.

33. The method of claim 31 further comprising:
receiving, by the configurable hardware logic stored on the first flight vehicle, one or more items of information encoded in the flow data from the one or more sensors positioned on the first flight vehicle based on one of the flow induced thrust or the flow induced lift generated by the second flight vehicle; and
identifying, by the configurable hardware logic stored on the first flight vehicle, the second flight vehicle based on the received one or more items of information.

34. The method of claim 33, wherein the one or more items of information are encoded in the flow data based on one or more actions of the second flight vehicle.

35. The method of claim 34, wherein the one or more actions comprise a propeller pulse, a rudder or elevator waggle, or a roll maneuver.

36. The method of claim 31, wherein the determining the relative location of the first flight vehicle with respect to the flow induced thrust or flow induced lift generated by the second flight vehicle based on the received flow data comprises determining one or more of swirl from thrust, downwash from lift, or clean air.

37. The method of claim 31, wherein the one or more sensors comprise hair cell sensors.

38. A flight vehicle comprising:
one or more sensors;
at least one of configurable hardware logic configured to be capable of implementing and a processor coupled to a memory and configured to execute programmed instructions stored in the memory comprising:
receiving flow data from the one or more sensors, wherein the flow data is based on one of a flow induced thrust or flow induced lift generated by a second flight vehicle;
determining a relative location of the flight vehicle with respect to the flow induced thrust or flow induced lift generated by the second flight vehicle based on the received flow data; and
identifying at least one operational action to follow the second flight vehicle based on the determined relative location of the flight vehicle with respect to the flow induced thrust or flow induced lift generated by the second flight vehicle.

39. The flight vehicle of claim 38, wherein determining the relative location of the flight vehicle with respect to the flow induced thrust or flow induced lift generated by the second flight vehicle based on the received flow data further comprises:
determining a time and frequency for the flow induced thrust or flow induced lift generated by the second flight vehicle; and
determining the relative location of the flight vehicle with respect to the flow induced thrust or flow induced lift generated by the second flight vehicle based on the determined time and frequency.

40. The flight vehicle of claim 38 further comprising one of additional configurable hardware logic configured to be capable of implementing and programmed instructions stored in the memory comprising:
receiving one or more items of information encoded in the flow data from the one or more sensors based on one of the flow induced thrust or the flow induced lift generated by the second flight vehicle; and
identifying the second flight vehicle based on the received one or more items of information.

41. The flight vehicle of claim 40, wherein the one or more items of information are encoded in the flow data based on one or more actions of the second flight vehicle.

42. The flight vehicle of claim 41, wherein the one or more actions comprise a propeller pulse, a rudder or elevator waggle, or a roll maneuver.

43. The flight vehicle of claim 38, wherein the determining the relative location of the flight vehicle with respect to the flow induced thrust or flow induced lift generated by the second flight vehicle based on the received flow data comprises determining one or more of swirl from thrust, downwash from lift, or clean air.

44. The flight vehicle of claim 38, wherein the one or more sensors comprise hair cell sensors.

45. A method for providing an informed launch for a flight vehicle, the method comprising:
receiving, by a computing device, wind data over a period of time from one or more sensors positioned on the flight vehicle when the flight vehicle is in a perched state;
determining, by the computing device, a direction and a speed from the wind data over the period of time; and
identifying, by the computing device, an opportunistic launch time based on the determined direction and the speed from the wind data.

46. The method of claim 45 further comprising:
providing, by the computing device, an instruction to the flight vehicle to perform a launch at the opportunistic launch time.

47. The method of claim 45, wherein identifying the opportunistic launch time further comprises:
determining, by the computing device, one or more microweather patterns based on the determined direction and speed from the wind data over the period of time; and
identifying, by the computing device, the opportunistic launch time based on the determined one or more microweather patterns.

48. The method of claim 45, wherein the opportunistic launch time is based on a head wind and a threshold wind speed.

49. The method of claim 45, wherein the one or more sensors comprise hair cell sensors.

50. A flight vehicle comprising:
one or more sensors;
at least one of configurable hardware logic configured to be capable of implementing and a processor coupled to a memory and configured to execute programmed instructions stored in the memory comprising:
receiving wind data over a period of time from the one or more sensors when the flight vehicle is in a perched state;
determining a direction and a speed from the wind data over the period of time; and
identifying an opportunistic launch time based on the determined direction and the speed from the wind data.

51. The flight vehicle of claim 50 further comprising one of additional configurable hardware logic configured to be capable of implementing and programmed instructions stored in the memory comprising:
providing an instruction to the flight vehicle to perform a launch at the opportunistic launch time.

52. The flight vehicle of claim 50 wherein identifying the opportunistic launch time further comprises:
determining one or more microweather patterns based on the determined direction and speed from the wind data over the period of time; and
identifying the opportunistic launch time based on the determined one or more microweather patterns.

53. The flight vehicle of claim 50, wherein the opportunistic launch time is based on a head wind and a threshold wind speed.

54. The flight vehicle of claim 50, wherein the one or more sensors comprise hair cell sensors.

55. The flight vehicle of claim 54, wherein the one or more sensors are positioned on an extendable member of the flight vehicle.

56. The flight vehicle of claim 55, wherein the extendable member is configured to be retracted prior to launch.

57. The flight vehicle of claim 50, wherein the flight vehicle is a fixed wing flight vehicle.

58. A method for providing for thermal soaring, the method comprising:
receiving, by a computing device, flow data from one or more sensors positioned on a flight vehicle;
determining, by the computing device, a change in bias in the flow data; and
identifying, by the computing device, presence of an updraft from a thermal based on the determined change in bias.

59. The method of claim 58, wherein identifying the presence of the updraft further comprises:
identifying, by the computing device, a direction of travel of the updraft and a rotation relative to the ground plane of the updraft.

60. A flight vehicle comprising:
one or more sensors;
at least one of configurable hardware logic configured to be capable of implementing and a processor coupled to a memory and configured to execute programmed instructions stored in the memory comprising:
receiving flow data from the one or more sensors;
determining a change in bias in the flow data; and
identifying presence of an updraft from a thermal based on the determined change in bias.

61. The flight vehicle of claim 60, wherein identifying the presence of the updraft further comprises:
identifying a direction of travel of the updraft and a rotation relative to the ground plane of the updraft.

62. The flight vehicle of claim 60, wherein the one or more sensors comprise hair cell sensors.
